(19) United States
(12) Patent Application Publication
(10) Pub. No.: US 2025/0246808 A1
(43) Pub. Date: Jul. 31, 2025

(54) ANTENNA MODULE AND WIRELESS COMMUNICATION DEVICE

(71) Applicant: Chiun Mai Communication Systems, Inc., New Taipei (TW)

(72) Inventors: LUNG-TA CHANG, New Taipei (TW); CHIA-HSIEN CHEN, New Taipei (TW); SHU-WEI JHANG, New Taipei (TW); CHE-CHENG KAO, New Taipei (TW)

(21) Appl. No.: 19/032,591

(22) Filed: Jan. 21, 2025

(30) Foreign Application Priority Data
Jan. 31, 2024 (TW) 113103854

(51) Int. Cl. H01Q 3/36; H01Q 1/28

(52) U.S. Cl. CPC H01Q 3/36; H01Q 1/288

(57) ABSTRACT

An antenna module and a wireless communication device for a low earth orbit satellite system are provided, including an antenna array and a phase shifter array. The antenna array includes a plurality of groups of antenna units, each of the plurality of groups of antenna units includes N antenna units. The phase shifter array includes a plurality of groups of phase shifters, each of the plurality of groups of phase shifters includes N phase shifters arranged corresponding to the N antenna units, the N phase shifters comprises a first phase shifter, a N^{th} phase shifter, and N−2 intermediate phase shifters arranged between the first phase shifter and the N^{th} phase shifter, a phase of an input signal of each of the N phase shifters to the corresponding antenna unit is a multiple of a minimum unit input phase of the phase shifter, wherein N is a positive integer greater than or equal to 3, and the multiple is 0 or any integer.

### CROSS-REFERENCE TO RELATED APPLICATIONS

This application claims priority to Taiwan Patent Application No. 113103854 filed on Jan. 31, 2024, in Taiwan Intellectual Property Office, the contents of which are incorporated by reference herein.

### FIELD

The subject matter herein generally relates to wireless communication technology field, and more particularly to an antenna module and a wireless communication device.

### BACKGROUND

In a traditional low earth orbit (LEO) satellite system, multiple antenna units are arranged at a preset distance to form a phased array antenna. Each antenna unit is connected to a phase shifter, and adjacent phase shifters input a fixed phase difference, so that the multiple antenna units can form a beam with a specific pointing angle. However, when the fixed phase difference input to adjacent phase shifters is a minimum adjustable indivisible unit of the phase shifter, the phase control angle is a minimum adjustable angle of the phased array antenna beam, because the phase control angle cannot be changed. Segmentation makes it not precise enough to adjust the angle of the phased array antenna beam, causing a certain degree of errors in the LEO satellite system.

### BRIEF DESCRIPTION OF THE DRAWINGS

Implementations of the present disclosure will now be described, by way of embodiments, with reference to the attached figures.

FIG. 1 is a functional block diagram of an antenna module according to some embodiments of the present application.

FIG. 2 is a structural schematic diagram of the antenna module according to some embodiments of the present application.

FIG. 3 is a structural schematic diagram of the antenna module according to a first embodiment of the present application.

FIG. 4 is a structural schematic diagram of the antenna module according to a second embodiment of the present application.

FIG. 5 is a structural schematic diagram of the antenna module according to a third embodiment of the present application.

FIG. 6 is a structural schematic diagram of the antenna module according to a fourth embodiment of the present application.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

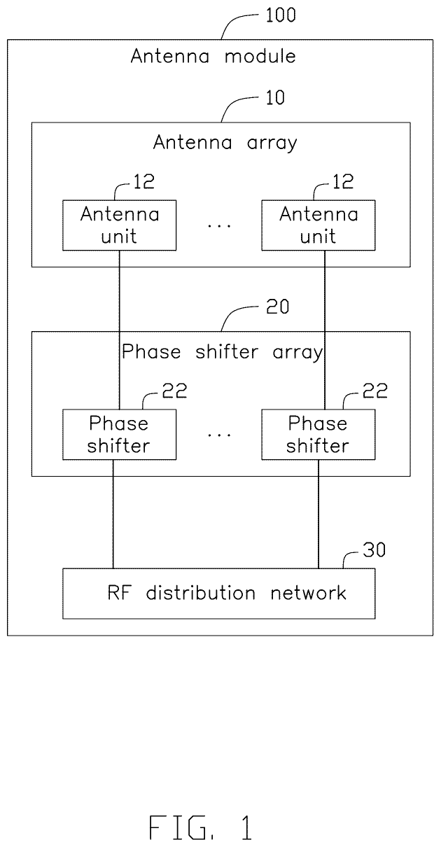

Referring to FIG. 1, an embodiment of the present application provides an antenna module 100 applied in a low earth orbit (LEO) satellite system. In some embodiments, the antenna module 100 may be applied in a wireless communication device, which may be, but is not limited to, an electronic device capable of wirelessly communicating with the LEO. The antenna module 100 may be used to form beamforming signals and transmit and receive radio beams to achieve wireless communication between the wireless communication device and the LEO.

In some embodiments, the antenna module 100 may include an antenna array 10, a phase shifter array 20, and a radio frequency (RF) distribution network 30. The antenna array 10, the phase shifter array 20, and the RF distribution network 30 are connected in sequence.

The antenna array 10 may include a plurality of groups of antenna unit 12, each group of antenna unit may include N antenna units 12. In some embodiments, the antenna units 12 are arranged in an array of a preset shape, which can form a group of antenna units of a preset shape of N*M. The preset shape can be an arrangement in a two-dimensional plane, including but not limited to linear, rectangular, square, plane regular triangle (or plane equilateral triangle), plane isosceles triangle, etc. That is, each group of antenna units is arranged in the preset shape. It is understood that, according to different preset shapes, spacing distances between the antenna units 12 can also be adjusted to be different. The antenna array 10 can be used to transmit and receive radio beams at a specific pointing angle (or beamforming angle). In some embodiments, N is a positive integer greater than or equal to 3.

The phase shifter array 20 may include a plurality of groups of phase shifters (or phaser) 22, and each group of phase shifters may include N phase shifters 22 arranged corresponding to the N antenna units 12. In some embodiments, each antenna unit 12 in the antenna array 10 is connected to one corresponding phase shifter 22. The phase shifter 22 can be used to adjust a phase of the input signal of the correspondingly connected antenna unit 12 so that the correspondingly connected antenna unit 12 can transmit a radio beam with a preset phase. Correspondingly, each group of phase shifters is arranged in a preset shape corresponding to each group of connected antenna units, such as linear, rectangular, square, plane regular triangle (or plane equilateral triangle), plane isosceles triangle, etc. In some embodiments, the phase shifter array 20 and the antenna array 10 can generate beamforming signals.

In some embodiments, each group of N phase shifters 22 may include a first phase shifter, an N^{th} phase shifter, and a plurality of intermediate phase shifters arranged between the first phase shifter and the N^{th} phase shifter. The first phase shifter and the N^{th} phase shifter may be the first and last phase shifters of the group of phase shifters, respectively, and the remaining plurality of intermediate phase shifters are arranged between the first and last phase shifters. For instance, when N is three, each group of phase shifters includes three phase shifters 22, which may include a first phase shifter, a second phase shifter, and a third phase shifter, wherein the second phase shifter is the intermediate phase shifter disposed between the first phase shifter and the third phase shifter. For instance, when N is five, each group of phase shifters includes five phase shifters 22, which may include a first phase shifter, a second phase shifter, a third phase shifter, a fourth phase shifter, and a fifth phase shifter, wherein the second phase shifter, the third phase shifter, and the fourth phase shifter are the three intermediate phase shifters disposed between the first phase shifter and the fifth phase shifter. The first phase shifter, the N^{th} phase shifter, and a plurality of intermediate phase shifters disposed between the first phase shifter and the N^{th} phase shifter are the phase shifters 22 having the same specifications.

In some embodiments, in each group of N phase shifters 22, N−2 intermediate phase shifters may be interspersed between the first phase shifter and the N^{th} phase shifter. For instance, when N is three, in each group of three phase shifters 22, one intermediate phase shifter may be interspersed between the first phase shifter and the third phase shifter. For instance, when N is five, in each group of five phase shifters 22, three intermediate phase shifters may be interspersed between the first phase shifter and the fifth phase shifter.

In some embodiments, each phase shifter 22 has a minimum unit input phase Φₘ. For example, if the input phase 360 degrees (°) is evenly divided into 64 equal parts, each equal part is approximately 5.625 degrees, and the minimum unit input phase Φₘ of each phase shifter 22 can be 5.625 degrees. Two adjacent antenna units 12 are separated by a spacing distance d, and the phases of the input signals from the two adjacent phase shifters 22 to the corresponding antenna units 12 have a fixed phase difference Φ, so the antenna array 10 can emit a radio beam with a specific pointing angle θ. The specific pointing angle θ of the radio beam can be obtained through formula (1):

$$θ = - {sin}^{- 1} ( \frac{λ}{d} \times \frac{∅}{360} ) \qquad formula ( 1 )$$

Wherein, λ is a wavelength of the RF input signal, d is the spacing distance between two adjacent antenna units 12, and Φ is the fixed phase difference between the phases of the input signals from the two adjacent phase shifters 22 to the corresponding antenna units 12. When the phases of the input signals from the two adjacent phase shifters 22 to the corresponding antenna units 12 have the fixed phase difference Φ which is the minimum unit input phase Φₘ of the phase shifter 22, the specific pointing angle θ of the radio beam is a minimum adjustable beam angle θₘ of the antenna array 10, that is, θ=θₘ.

The RF distribution network 30 is respectively connected to each phase shifter 22 in the phase shifter array 20. The RF distribution network 30 can be used to provide radio frequency signals to the phase shifters 22 and the antenna units 12.

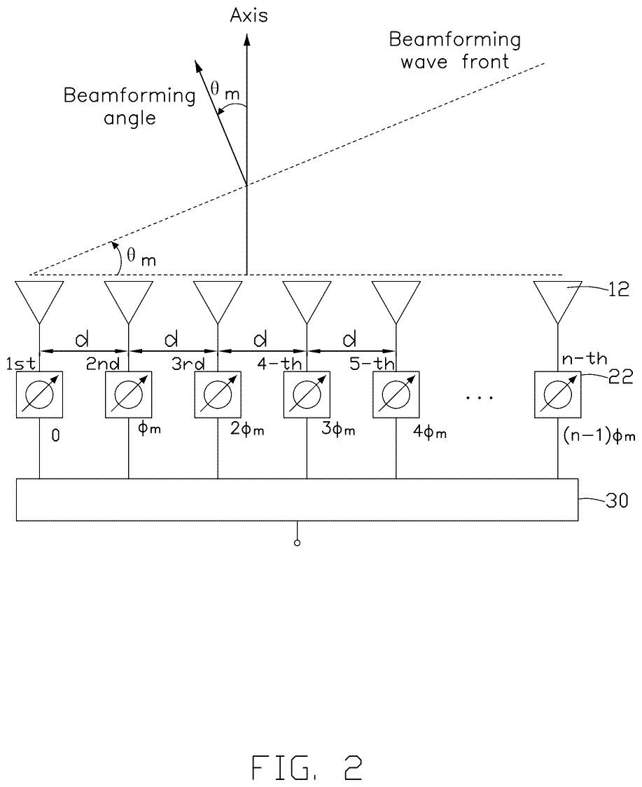

Referring to FIG. 2, some embodiments provide an antenna module 100, where the antenna array 10 may include a plurality of groups of antenna units 12, each group of antenna units 12 may include at least N antenna units 12, the N antenna units 12 are arranged linearly, and two adjacent antenna units 12 are spaced apart by a same spacing distance d. Each antenna unit 12 is connected to a corresponding phase shifter 22, and the phase shifter 22 is further connected to the RF distribution network 30 to form a radio beam transceiver path. A quantity of antenna units 12 is equal to a quantity of phase shifters 22, which are arranged correspondingly one to one. That is, each group of phase shifters also includes N phase shifters 22. In each group of phase shifters, the phase difference between the input signals of two adjacent phase shifters 22 to the corresponding antenna units 12 is the minimum unit input phase of the phase shifter 22, that is, the phase difference between the input signals of the two adjacent phase shifters 22 is the minimum unit input phase Φₘ. For instance, a phase arrangement of the input signals from the first phase shifter to the N^{th} phase shifter to the corresponding antenna units 12 may be 0, Φₘ, 2Φₘ, 3Φₘ, 4Φₘ, . . . , (n−1)Φₘ. The specific pointing angle (or beamforming angle) of the radio beam transmitted and received by the antenna array 10 is θ=θₘ, that is, the minimum adjustable angle (or minimum beamforming angle) of the antenna array 10 is θ=θₘ. In some embodiments, as shown in FIG. 2, an angle between the beamforming angle (or beamforming direction) and the axis (Boresight) is the minimum adjustable angle (or minimum beamforming angle) θₘ of the antenna array 10, and an angle between the beamforming wave front and the plane of the antenna array 10 is the minimum adjustable angle (or minimum beamforming angle) Om of the antenna array 10.

For instance, when the phases of the input signals from two adjacent phase shifters 22 to the corresponding antenna units 12 have a fixed phase difference Φ, which is the minimum unit input phase Φₘ of the phase shifter 22, that is, Φ=Φₘ=5.625°, a center frequency of the RF input signal is 11.7 GHz (Gigahertz), a wavelength λ of the RF input signal is 25.641 mm (millimeters), and the spacing distance d between the two adjacent antenna units 12 is 12 mm, substituting into formula (1) it can be calculated that the specific pointing angle θ of the radio beam is approximately 1.913°, that is, the minimum adjustable angle of the antenna array 10 is approximately 1.913°.

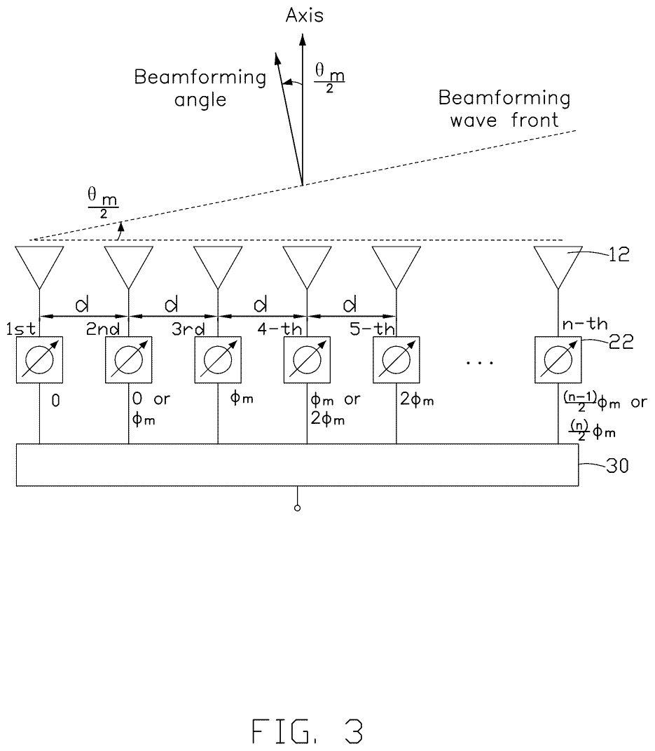

Referring to FIG. 3, a first embodiment of the present application provides an antenna module 100, where the antenna array 10 may include a plurality of groups of antenna units 12, each group of antenna units 12 may include at least N antenna units 12, the N antenna units 12 are arranged linearly, and two adjacent antenna units 12 are spaced apart by a same spacing distance d. Each antenna unit 12 is connected to a corresponding phase shifter 22, and the phase shifter 22 is further connected to the RF distribution network 30 to form a radio beam transceiver path. A quantity of antenna units 12 is equal to a quantity of phase shifters 22, which are arranged correspondingly one to one. That is, each group of phase shifters also includes N phase shifters 22. In each group of phase shifters, the phase of the input signal of each phase shifter 22 to the corresponding antenna unit 12 is a multiple of the minimum unit input phase of the phase shifter 22, where N is a positive integer greater than or equal to 3, and the multiple is 0 or any integer.

In some embodiments, in each group of phase shifters, the phases of the input signals from the first phase shifter and the N^{th} phase shifter to the corresponding antenna units 12 are two different multiples of the minimum unit input phase of the phase shifter 22. For example, the phase of the input signal of the first phase shifter to the corresponding antenna unit 12 is 0 times the minimum unit input phase of the phase shifter 22, that is, 0; and the phase of the input signal of the N^{th} phase shifter to the corresponding antenna unit 12 is 1 times the minimum unit input phase of the phase shifter 22, that is, Φₘ. Then the phase difference (between the first phase shifter and the N^{th} phase shifter is 1 times Φₘ, that is, Φ=Φₘ. The phase of the input signal from the intermediate phase shifter arranged between the first phase shifter and the N^{th} phase shifter to the corresponding antenna unit 12 can be within a range of [0, Φₘ] and be a multiple of the minimum unit input phase of the phase shifter 22, that is, the phase of the input signal from the intermediate phase shifter to the corresponding antenna unit 12 can be 0 or Φₘ.

In some embodiments, in the N phase shifters 22 of each group of phase shifters, the phase of the input signal from each phase shifter 22 to the corresponding antenna unit 12 is a multiple of the minimum unit input phase of the phase shifter 22. The phase of the input signal from each phase shifter 22 to the corresponding antenna unit 12 can be calculated using formula (2) or formula (3). When the N^{th} antenna unit 12 is an odd number of antenna units 12, or the N^{th} phase shifter 22 is an odd number of phase shifters 22, that is, N is an odd number, the phase of the input signal of the phase shifter 22 to the corresponding antenna unit 12 can be calculated by formula (2):

$$∅ = Round ( \frac{2 π \times d \times sin ( θ )}{λ \times {∅}_{m}} ) \times \frac{( n - 1 )}{2} {∅}_{m} \qquad formula ( 2 )$$

Wherein, Φ is the phase of the input signal of the phase shifter 22 to the corresponding antenna unit 12, θ=−180°˜180°, λ, is the wavelength of the RF input signal, d is the spacing distance between two adjacent antenna units 12, Φₘ is the minimum unit input phase of the phase shifter 22, and Round( ) is rounded to the nearest integer.

When the N^{th} antenna units 12 is an even number of antenna units 12, or the N^{th} phase shifter 22 is an even number of phase shifters 22, that is, N is an even number, the phase of the input signal of the phase shifter 22 to the corresponding antenna unit 12 can be calculated by formula (3):

$$∅ = Round ( \frac{2 π \times d \times sin ( θ )}{λ \times {∅}_{m}} \times \frac{( n - 2 )}{2} {∅}_{m} + Round ( \frac{2 π \times d \times sin ( θ )}{2 \times λ \times {∅}_{m}} ) \times {∅}_{m} \qquad formula ( 3 )$$

Wherein, Φ is the phase of the input signal of the phase shifter 22 to the corresponding antenna unit 12, θ=−180°˜180°, λ is the wavelength of the RF input signal, d is the spacing distance between two adjacent antenna units 12, Φₘ is the minimum unit input phase of the phase shifter 22, and Round( ) is rounded to the nearest integer.

In some embodiments, in the N−2 intermediate phase shifters interspersed between the first phase shifter and the N^{th} phase shifter, the input phase of each intermediate phase shifter is equal to the input phase of each first phase shifter and the input phase of the N^{th} phase shifter in each group of phase shifters, or is between the input phase of each first phase shifter and the input phase of the N^{th} phase shifter in each group of phase shifters. For instance, when N is three, the phase of the input signal of the first phase shifter to the corresponding antenna unit 12 is 0 times the input phase Φₘ of the minimum unit input phase of the phase shifter 22, that is, 0; and the phase of the input signal of the third phase shifter to the corresponding antenna unit 12 is 1 times the minimum unit input phase of the phase shifter 22, that is, Φₘ. Then the phase of the input signal from the intermediate phase shifter (i.e., the second phase shifter) to the corresponding antenna unit 12 is in a range [0, Φₘ] and is a multiple of the minimum unit input phase of the phase shifter 22, that is, the phase of the input signal from the intermediate phase shifter (i.e., the second phase shifter) to the corresponding antenna unit 12 can be 0 or Φₘ.

In some embodiments, in the N−2 intermediate phase shifters arranged between the first phase shifter and the N^{th} phase shifter, the input phase of each intermediate phase shifter is increasing or decreasing in sequence and is a multiple of the minimum unit input phase of the intermediate phase shifter. For instance, when N is five, the phase of the input signal of the first phase shifter to the corresponding antenna unit 12 is 0 times the input phase Φₘ of the minimum unit input phase of the phase shifter 22, that is, 0; and the phase of the input signal of the fifth phase shifter to the corresponding antenna unit 12 is 1 times the minimum unit input phase of the phase shifter 22, that is, Φₘ. Then the phases of the input signals from the intermediate phase shifters (i.e., the second phase shifter, the third phase shifter, and the fourth phase shifter) to the corresponding antenna units 12 are in a range [0, Φₘ] and are multiples of the minimum unit input phase of the phase shifter 22, that is, the phases of the input signals from the intermediate phase shifters (i.e., the second phase shifter, the third phase shifter, and the fourth phase shifter) to the corresponding antenna units 12 can be 0 or Φₘ, and the phases of the input signals from the intermediate phase shifters (i.e., the second phase shifter, the third phase shifter, and the fourth phase shifter) to the corresponding antenna units 12 are increasing or decreasing in sequence. For instance, in an increasing embodiment, the phase of the input signal of the second phase shifter to the corresponding antenna unit 12 is 0, the phase of the input signal of the third phase shifter to the corresponding antenna unit 12 is Φₘ, the phase of the input signal of the fourth phase shifter to the corresponding antenna unit 12 is Φₘ. In another increasing embodiment, the phase of the input signal of the second phase shifter to the corresponding antenna unit 12 is 0, the phase of the input signal of the third phase shifter to the corresponding antenna unit 12 is 0, the phase of the input signal of the fourth phase shifter to the corresponding antenna unit 12 is Φₘ.

Please refer to FIG. 3, each group of phase shifters may include three phase shifters 22, and each group of antenna units may include three antenna units 12, that is, each group of antenna units is separated by two spacing distance d (i.e., 2d). The phase difference Φ between the first phase shifter and the third phase shifter is 1 times Φₘ, that is, Φ=Φₘ. Then, the specific pointing angle θ of the radio beam emitted by the antenna array 10 can be calculated by formula (1):

$$θ = - {sin}^{- 1} ( \frac{λ}{2 d} \times \frac{{∅}_{m}}{360} ) = \frac{{θ}_{m}}{2}$$

According to formula (1), the specific pointing angle of the radio beam emitted by the antenna array 10 is θ=θₘ/2. Therefore, the beamforming resolution (or the minimum adjustable beam angle) can be increased by 2 times, making the minimum adjustable beam angle of the antenna array 10 smaller, so that the adjustable beam emission of the antenna array 10 is more accurate.

For instance, the phase of the input signal of each phase shifter 22 to the corresponding antenna unit 12 is a multiple of the minimum unit input phase Φₘ of the phase shifter 22, Φₘ=5.625°, the center frequency of the RF input signal is 11.7 GHz (Gigahertz), the wavelength λ of the RF input signal is 25.641 mm (millimeters), and the spacing distance d between two adjacent antenna units 12 is 12 mm. Substituting into formula (1) for calculation, the specific pointing angle θ of the radio beam is approximately 0.957°, that is, the minimum adjustable angle of the antenna array 10 is approximately 0.9570.

It can be understood that in the antenna module 100 shown in FIG. 2, the phase difference between the first phase shifter and the third phase shifter is twice the minimum unit input phase Φₘ of the phase shifter 22, that is, 2Φₘ; in the antenna module 100 shown in FIG. 3, the phase difference between the first phase shifter and the third phase shifter is the minimum unit input phase Φₘ of the phase shifter 22. The specific pointing angle of the radio beam of the antenna module 100 shown in FIG. 3 may be 1/(N−1) of the specific pointing angle of the radio beam of the antenna module 100 shown in FIG. 2, or ½ when N is three. Please refer to Table 1 and Table 2, Table 1 shows exemplary phase values of input signals from the phase shifters of the antenna module 100 shown in FIG. 2 to the corresponding antenna units 12. Table 2 shows exemplary phase values of input signals from the phase shifters of the antenna module 100 shown in FIG. 3 to the corresponding antenna units 12, wherein the unit of the phase value is degree (°).

TABLE 1

| | First | Second | Third | Fourth |
|---|---|---|---|---|
| | phase | phase | phase | phase |
| | shifter | shifter | shifter | shifter |
| exemplary phase | 0.000 | 5.625 | 11.250 | 16.875 |
| values (°) | | | | |

TABLE 2

| | First | Second | Third | Fourth | Fifth |
|---|---|---|---|---|---|
| | phase | phase | phase | phase | phase |
| | shifter | shifter | shifter | shifter | shifter |
| exemplary phase | 0.000 | 0.000 | 5.625 | 5.625 | 11.250 |
| values (°) | | | | | |

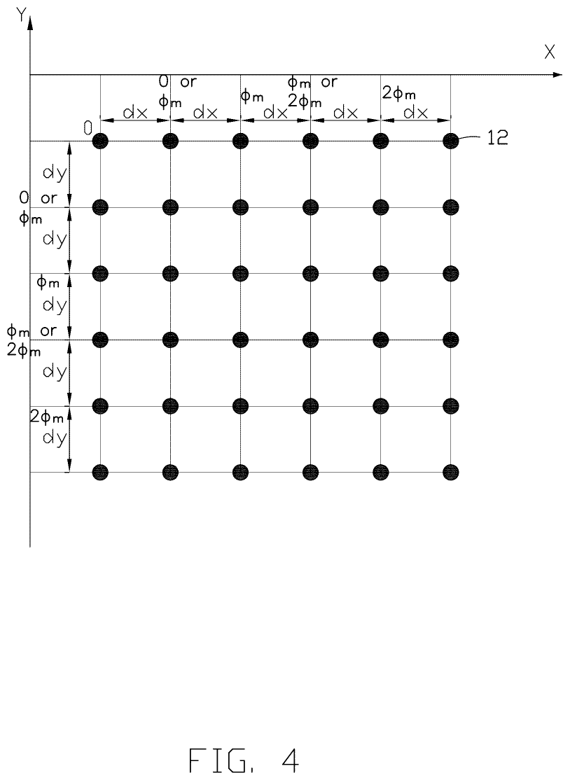

Referring to FIG. 4, the second embodiment of the present application provides an antenna module 100, the antenna array 10 may include a plurality of groups of antenna units 12, each group of antenna units may include at least N antenna units 12 linearly arranged along an x direction and at least M antenna units 12 linearly arranged along a y direction, thereby forming an N*M planar rectangular arrangement. The N antenna units 12 are linearly arranged along the x direction at an equal spacing distance dx, that is, two adjacent antenna units 12 in the x direction are separated by the same spacing distance dx; the M antenna units 12 are linearly arranged along the y direction at an equal spacing distance dy, that is, two adjacent antenna units 12 in the y direction are separated by the same spacing distance dy. In some embodiments, the spacing distance dx may not be equal to the spacing distance dy. Each antenna unit 12 is connected to a corresponding phase shifter 22, and the phase shifter 22 is further connected to the RF distribution network 30 to form a transceiver path of a radio beam. The quantity of antenna units 12 is equal to the quantity of phase shifters 22, and the antenna units 12 and the phase shifters 22 are correspond one to one. That is, each group of phase shifters also includes N*M phase shifters 22. In each group of phase shifters, the phase of the input signal of each phase shifter 22 to the corresponding antenna unit 12 is a multiple of the minimum unit input phase of the phase shifter 22, where N is a positive integer greater than or equal to 3, and the multiple is 0 or any integer.

In some embodiments, in each group of phase shifters, the phases of the input signals from the first phase shifter and the N^{th} phase shifter along the x direction to the corresponding antenna units 12 are two different multiples of the minimum unit input phase of the phase shifter 22, and the phases of the input signals from the first phase shifter and the N^{th} phase shifter along the y direction to the corresponding antenna unit 12 are two different multiples of the minimum unit input phase of the phase shifter 22. For example, along the x direction, the phase of the input signal from the first phase shifter at every two spacing distances dx (i.e., 2dx) to the corresponding antenna unit 12 is 0 times the minimum unit input phase of the phase shifter 22, i.e., 0, and the phase of the input signal from the N^{th} phase shifter to the corresponding antenna unit 12 is 1 times the minimum unit input phase of the phase shifter 22, i.e., Φₘ. Then, the phase difference Φ between the first phase shifter and the N^{th} phase shifter along the x direction is 1 times Φₘ, i.e., Φ=Φₘ. Along the y direction, the phase of the input signal of the first phase shifter at every two spacing distances dy (i.e., 2dy) to the corresponding antenna unit 12 is 0 times the minimum unit input phase of the phase shifter 22, i.e., 0, and the phase of the input signal of the N^{th} phase shifter to the corresponding antenna unit 12 is 1 times the minimum unit input phase of the phase shifter 22, i.e., Φₘ. Then, the phase difference Φ between the first phase shifter and the N^{th} phase shifter along the y direction is 1 times Φₘ, i.e., Φ=Φₘ. The phases of the input signals from the intermediate phase shifters arranged between the first phase shifter and the N^{th} phase shifter along the x direction and along the y direction to the corresponding antenna units 12 can be located in the range [0, Φₘ] and are multiples of the minimum unit input phase of the phase shifter 22, that is, the phases of the input signals from the intermediate phase shifters along the x direction and along the y direction to the corresponding antenna unit 12 can be 0 or Φₘ.

For instance, in an increasing specific embodiment, the phases of the input signals from the first phase shifter and the third phase shifter to the corresponding antenna units 12 along the x direction are 0 and Φₘ respectively, and the phase of the input signal from the second phase shifter to the corresponding antenna unit 12 is 0; the phases of the input signals from the first phase shifter and the third phase shifter to the corresponding antenna units 12 along the y direction are 0 and Φₘ respectively, and the phase of the input signal from the second phase shifter to the corresponding antenna unit 12 is 0. In another increasing specific embodiment, the phases of the input signals from the first phase shifter and the third phase shifter to the corresponding antenna units 12 along the x direction are 0 and Φₘ respectively, and the phase of the input signal from the second phase shifter to the corresponding antenna unit 12 is Φₘ; the phases of the input signals from the first phase shifter and the third phase shifter to the corresponding antenna units 12 along the y direction are 0 and Φₘ respectively, and the phase of the input signal from the second phase shifter to the corresponding antenna unit 12 is Φₘ.

In some embodiments, in each group of N*M phase shifters 22, component angles θx and θy of the specific pointing angles of the radio beam (or beamforming signal) emitted by the antenna array 10 in the x direction and the y direction can be obtained by formula (4):

$${θ}_{x} = - {sin}^{- 1} ( \frac{λ}{2 d} \times \frac{∅}{360} ) , {θ}_{y} = - {sin}^{- 1} ( \frac{λ}{2 d} \times \frac{∅}{360} ) \qquad formula ( 4 )$$

Wherein, λ is the wavelength of the RF input signal, d is the spacing distance dx and dy between two adjacent antenna units 12 in the x direction and y direction respectively, and Φ is the minimum unit input phase Φₘ of the phase shifter 22, that is, Φ=Φₘ.

For instance, when N is three, M is three, that is the third phase shifter 22 in the x direction and the y direction can set the input signal to be the minimum unit input phase Φₘ. The phase of the input signal from each phase shifter 22 to the corresponding antenna unit 12 is a multiple of the minimum unit input phase Φₘ of the phase shifter 22, Φₘ=5.625°, the center frequency of the RF input signal is 11.7 GHz (Gigahertz), and the wavelength λ of the RF input signal is 25.641 mm (millimeters), when the spacing distance d between two adjacent antenna units 12 is 12 mm, substituting into formula (4) to calculate, the component angle θx of the specific pointing angle θ of the radio beam in the x direction is approximately 0.975°, that is, the minimum adjustable angle of the antenna array 10 in the x direction is approximately 0.975°. The component angle θy of the specific pointing angle θ of the radio beam in the y direction is approximately 0.975°, that is, the minimum adjustable angle of the antenna array 10 in the y direction is approximately 0.975°. In the antenna module 100 shown in FIG. 2, the phase difference between the first phase shifter and the third phase shifter is twice the minimum unit input phase Φₘ of the phase shifter 22, i.e., 2Φₘ; in the antenna module 100 shown in FIG. 3, the phase difference between the first phase shifter and the third phase shifter is the minimum unit input phase Φₘ of the phase shifter 22. The specific pointing angle of the radio beam of the antenna module 100 shown in FIG. 4 may be 1/(N−1) of the specific pointing angle of the radio beam of the antenna module 100 shown in FIG. 2, or ½ when N is three.

For instance, when N is five, M is five, that is the fifth phase shifter 22 in the x direction and the y direction can set the input signal to be the minimum unit input phase Φₘ. The phase of the input signal from each phase shifter 22 to the corresponding antenna unit 12 is a multiple of the minimum unit input phase Φₘ of the phase shifter 22, Φₘ=5.625°, the center frequency of the RF input signal is 11.7 GHz (Gigahertz), and the wavelength λ of the RF input signal is 25.641 mm (millimeters), when the spacing distance d between two adjacent antenna units 12 is 12 mm, substituting into formula (4) to calculate, the component angle θx of the specific pointing angle θ of the radio beam in the x direction is approximately 0.478°, that is, the minimum adjustable angle of the antenna array 10 in the x direction is approximately 0.478°. The component angle θy of the specific pointing angle θ of the radio beam in the y direction is approximately 0.478°, that is, the minimum adjustable angle of the antenna array 10 in the y direction is approximately 0.478°. In the antenna module 100 shown in FIG. 2, the phase difference between the first phase shifter and the fifth phase shifter is four times the minimum unit input phase Φₘ of the phase shifter 22, i.e., 4Φm; in the antenna module 100 shown in FIG. 4, the phase difference between the first phase shifter and the fifth phase shifter is the minimum unit input phase Φₘ of the phase shifter 22. The specific pointing angle of the radio beam of the antenna module 100 shown in FIG. 4 may be 1/(N−1) of the specific pointing angle of the radio beam of the antenna module 100 shown in FIG. 2, or ¼ when N is five.

In some embodiments, in each group of N*M phase shifters 22, the phase of the input signal from each phase shifter 22 to the corresponding antenna unit 12 can be calculated using different formulas according to the arrangement positions of the phase shifters 22. When the arrangement of the (N, M)^{th} phase shifter 22 in the x direction and the y direction are odd numbers, that is, (odd number, odd number), the phase of the input signal of the (N, M)^{th} phase shifter 22 to the corresponding antenna unit 12 can be calculated by formula (5):

$$∅ = Round ( \frac{2 π \times d x \times sin ( {θ}_{x} )}{λ \times {∅}_{m}} ) \frac{( n - 1 )}{2} {∅}_{m} + Round ( \frac{2 π \times dy \times sin ( {θ}_{y} )}{λ \times {∅}_{m}} ) \frac{( n - 1 )}{2} {∅}_{m} \qquad formula ( 5 )$$

When the arrangement of the (N, M)^{th} phase shifters 22 in the x direction is an even number and the arrangement in the y direction is an odd number, that is, (even number, odd number), the phase of the input signal of the (N, M)^{th} phase shifter 22 to the corresponding antenna unit 12 can be calculated by formula (6):

$$∅ = Round ( \frac{2 π \times d x \times sin ( {θ}_{x} )}{λ \times {∅}_{m}} ) x \frac{( n - 2 )}{2} {∅}_{m} + Round ( \frac{2 π \times d x \times sin ( {θ}_{x} )}{2 \times λ \times {∅}_{m}} ) x {∅}_{m} + Round ( \frac{2 π \times dy \times sin ( {θ}_{y} )}{λ \times {∅}_{m}} ) \frac{( n - 1 )}{2} {∅}_{m} \qquad formula ( 6 )$$

When the arrangement of the (N, M)^{th} phase shifters 22 in the x direction is an odd number and the arrangement in the y direction is an even number, that is, (odd number, even number), the phase of the input signal of the (N, M)^{th} phase shifter 22 to the corresponding antenna unit 12 can be calculated by formula (7):

$$∅ = Round ( \frac{2 π \times d x \times sin ( {θ}_{x} )}{λ \times {∅}_{m}} ) \frac{( n - 1 )}{2} {∅}_{m} + Round ( \frac{2 π \times dy \times sin ( {θ}_{y} )}{λ \times {∅}_{m}} ) x \frac{( n - 2 )}{2} {∅}_{m} + Round ( \frac{2 π \times dy \times sin ( {θ}_{y} )}{λ \times {∅}_{m}} ) x {∅}_{m} \qquad formula ( 7 )$$

When the arrangement of the (N, M)^{th} phase shifter 22 in the x direction and the y direction are even numbers, that is, (even number, even number), the phase of the input signal of the (N, M)^{th} phase shifter 22 to the corresponding antenna unit 12 can be calculated by formula (8):

$$∅ = Round ( \frac{2 π \times d x \times sin ( {θ}_{x} )}{λ \times {∅}_{m}} ) x \frac{( n - 2 )}{2} {∅}_{m} + Round ( \frac{2 π \times d x \times sin ( {θ}_{x} )}{λ \times {∅}_{m}} ) x {∅}_{m} + Round ( \frac{2 π \times dy \times sin ( {θ}_{y} )}{λ \times {∅}_{m}} ) x \frac{( n - 2 )}{2} {∅}_{m} + Round ( \frac{2 π \times dy \times sin ( {θ}_{y} )}{λ \times {∅}_{m}} ) x {∅}_{m} \qquad formula ( 8 )$$

Wherein, Φ is the phase of the input signal of the phase shifter 22 to the corresponding antenna unit 12, θx, θy=−180°˜180°, λ is the wavelength of the RF input signal, d is the spacing distance between two adjacent antenna units 12, <Φₘ is the minimum unit input phase of the phase shifter 22, and Round( ) is rounded to the nearest integer.

From formula (4) to formula (8), it can be calculated that the specific pointing angle θ=θₘ/2 of the radio beam emitted by the antenna array 10, therefore, the beamforming resolution (or the minimum adjustable beam angle) can be increased by 2 times, so that the minimum adjustable angle of the beam of the antenna array 10 is smaller, and the adjustable beam emission of the antenna array 10 is more precise.

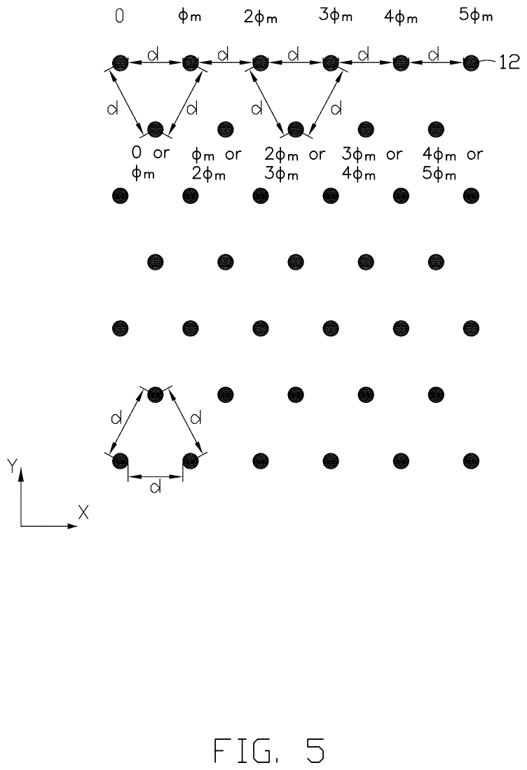

Referring to FIG. 5, the third embodiment of the present application provides an antenna module 100, the antenna array 10 may include a plurality of groups of antenna units 12, the plurality of antenna units 12 are N antenna units 12 arranged linearly along the x direction at an equal spacing distance d and M antenna units 12 arranged linearly along the y direction at the equal spacing distance d, thereby forming an N*M antenna array, and the antenna units 12 of each two adjacent rows are staggered, and the antenna units 12 of each two adjacent columns are staggered. That is to say, in one embodiment of the present application, in the plurality groups of antenna units, two adjacent rows of antenna units 12, and between two adjacent antenna units 12 in one row there is an antenna unit 12 in another adjacent row that is staggered. In a specific embodiment of the present application, in each group of antenna units, each group of antenna units forms two adjacent rows of the N antenna units 12, and between two adjacent antenna units 12 in one row there is an antenna unit 12 in another adjacent row that is staggered. More specifically, each group of antenna units may include at least two adjacent antenna units 12 located in the a^{th} row and one antenna unit 12 located in the a+1^{th} row or the a−1^{th} row, and the antenna unit 12 located in the a+1^{th} row or the a−1^{th} row is correspondingly arranged between the two adjacent antenna units 12 located in the a^{th} row, the antenna unit 12 located in the a+1^{th} row or the a−1^{th} row is respectively arranged at an equal spacing distance d from the two adjacent antenna units 12 located in the a^{th} row, so that the group of antenna units forms a planar regular triangle (or a planar equilateral triangle) arrangement. In some embodiments, a is a positive integer greater than or equal to 1 and less than or equal to M. Each antenna unit 12 is connected to a corresponding phase shifter 22, the phase shifter 22 is further connected to the RF distribution network 30 to form a radio beam transceiver path. The quantity of antenna units 12 is equal to the quantity of phase shifters 22, and the antenna units 12 and the phase shifters 22 correspond one to one. That is, each group of phase shifters also includes two adjacent phase shifters 22 located in the a^{th} row and one phase shifter 22 located in the a+1^{th} row or the a−1^{th} row. In each group of phase shifters, the phase of the input signal of each phase shifter 22 to the corresponding antenna unit 12 is a multiple of the minimum unit input phase of the phase shifter 22, where N is a positive integer greater than or equal to 3, and the multiple is 0 or any integer.

In some embodiments, in each group of phase shifters, the phases of the input signals from two adjacent phase shifters along the x direction to the corresponding antenna units 12 are two different multiples of the minimum unit input phase of the phase shifter 22. For example, along the x direction, the phase difference of the input signal of each two adjacent phase shifters separated by the spacing distance d to the corresponding antenna unit 12 is 1 times Φₘ, that is, 0, Φₘ, 2Φₘ, 3Φₘ, 4Φₘ, . . . , (n−1)Φₘ. For instance, in a group of phase shifters, when the phases of the input signals from two adjacent phase shifters separated by the spacing distance d along the x direction to the corresponding antenna units 12 are 0 and Φₘ, the phase of the input signal from the phase shifter located in another adjacent row to the corresponding antenna unit 12 can be 0 or Φₘ. In another group of phase shifters, when the phases of the input signals from two adjacent phase shifters separated by the spacing distance d along the x direction to the corresponding antenna units 12 are Φₘ and 2Φₘ, the phase of the input signal from the phase shifter located in another adjacent row to the corresponding antenna unit 12 can be Φₘ or 2Φₘ. In another group of phase shifters, when the phases of the input signals from two adjacent phase shifters separated by the spacing distance d along the x direction to the corresponding antenna units 12 are 2Φₘ and 3Φₘ, the phase of the input signal from the phase shifter located in another adjacent row to the corresponding antenna unit 12 can be 2Φₘ or 3Φₘ. In another group of phase shifters, when the phases of the input signals from two adjacent phase shifters separated by the spacing distance d along the x direction to the corresponding antenna units 12 are 3Φₘ and 4Φₘ, the phase of the input signal from the phase shifter located in another adjacent row to the corresponding antenna unit 12 can be 3Φₘ or 4Φₘ. In another group of phase shifters, when the phases of the input signals from two adjacent phase shifters separated by the spacing distance d along the x direction to the corresponding antenna units 12 are 4Φₘ and 5Φₘ, the phase of the input signal from the phase shifter located in another adjacent row to the corresponding antenna unit 12 can be 4Φₘ or 5Φₘ.

In some embodiments, in the N*M phase shifters 22, the component angles θx and θy of the specific pointing angles of the radio beam (or beamforming signal) emitted by the antenna array 10 in the x direction and the y direction can be obtained by formula (9):

$${θ}_{x} = - {sin}^{- 1} ( \frac{λ}{d} \times \frac{∅}{360} ) , {θ}_{y} = - {sin}^{- 1} ( \frac{2 λ}{\sqrt{3} d} \times \frac{∅}{360} ) \qquad formula ( 9 )$$

Wherein, λ is the wavelength of the RF input signal, d is the spacing distance between two adjacent antenna units 12, Φ is the minimum unit input phase of the phase shifter 22, that is Φ=Φₘ.

In some embodiments, in each group of phase shifters 22 arranged in the plane regular triangle (or the plane equilateral triangle), the phase of the input signal from each phase shifter 22 to the corresponding antenna unit 12 can be calculated by different formulas according to the arrangement position of the phase shifter 22. When M of the (N, M)^{th} phase shifter 22 is an odd number, the phase of the input signal from the (N, M)^{th} phase shifter 22 to the corresponding antenna unit 12 can be calculated by formula (10):

$$∅ = Round ( \frac{2 π \times d x \times sin ( {θ}_{x} )}{λ \times {∅}_{m}} ) ( n - 1 ) {∅}_{m} + Round ( \frac{√ 3 \times π \times d \times sin ( {θ}_{y} )}{λ \times {∅}_{m}} ) ( m - 1 ) {∅}_{m} \qquad formula ( 10 )$$

When M of the (N, M)^{th} phase shifter 22 is an even number, the phase of the input signal from the (N, M)^{th} phase shifter 22 to the corresponding antenna unit 12 can be calculated by formula (11):

$$∅ = Round ( \frac{2 π \times d \times sin ( {θ}_{x} )}{λ \times {∅}_{m}} ) ( n - 1 ) {∅}_{m} + Round ( \frac{2 π \times d \times sin ( {θ}_{x} )}{2 \times λ \times {∅}_{m}} ) {∅}_{m} + Round ( \frac{√ 3 \times π \times d \times sin ( {θ}_{y} )}{λ \times {∅}_{m}} ) ( m - 1 ) {∅}_{m} \qquad formula ( 11 )$$

Wherein, Φ is the phase of the input signal of the phase shifter 22 to the corresponding antenna unit 12, θx, θy=−180°˜180°, λ is the wavelength of the RF input signal, d is the spacing distance between two adjacent antenna units 12, Φₘ is the minimum unit input phase of the phase shifter 22, and Round( ) is rounded to the nearest integer.

From formula (9) to formula (11), it can be calculated that the specific pointing angle θ=θₘ/2 of the radio beam emitted by the antenna array 10. Therefore, the beamforming resolution (or the minimum adjustable beam angle) can be increased by 2 times, making the minimum adjustable beam angle of the antenna array 10 smaller, so that the adjustable beam emission of the antenna array 10 is more accurate.

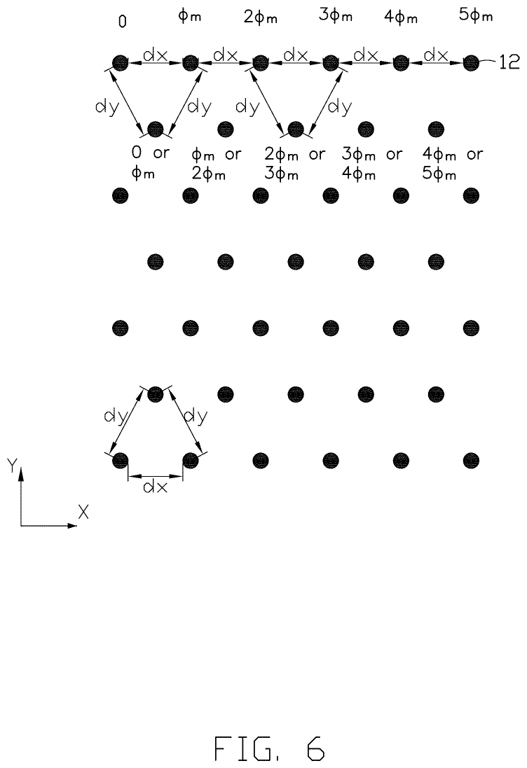

Referring to FIG. 6, the fourth embodiment of the present application provides an antenna module 100, the antenna array 10 may include a plurality of groups of antenna units 12, the plurality of antenna units 12 are N antenna units 12 arranged linearly along the x direction at an equal spacing distance dx and M antenna units 12 arranged linearly along the y direction at the equal spacing distance dy, thereby forming an N*M antenna array, and the antenna units 12 of each two adjacent rows are staggered, and the antenna units 12 of each two adjacent columns are staggered. That is to say, in one embodiment of the present application, in the plurality groups of antenna units, two adjacent rows of antenna units 12, and between two adjacent antenna units 12 in one row there is an antenna unit 12 in another adjacent row that is staggered. In a specific embodiment of the present application, in each group of antenna units, each group of antenna units forms two adjacent rows of the N antenna units 12, and between two adjacent antenna units 12 in one row there is an antenna unit 12 in another adjacent row that is staggered. More specifically, each group of antenna units may include at least two adjacent antenna units 12 located in the a^{th} row and one antenna unit 12 located in the a+1^{th} row or the a−1^{th} row, and the antenna unit 12 located in the a+1^{th} row or the a−1^{th} row is correspondingly arranged between two adjacent antenna units 12 located in the a^{th} row. The two adjacent antenna units 12 located in the a^{th} row are arranged at an equal spacing distance dx, and the antenna unit 12 located in the a+1^{th} row or the a−1^{th} row is respectively arranged at an equal spacing distance dy with the two adjacent antenna units 12 located in the a^{th} row, so that the group of antenna units forms a planar isosceles triangle arrangement. In some embodiments, a is a positive integer greater than or equal to 1 and less than or equal to M. Each antenna unit 12 is connected to a corresponding phase shifter 22, the phase shifter 22 is further connected to the RF distribution network 30 to form a radio beam transceiver path. The quantity of antenna units 12 is equal to the quantity of phase shifters 22, and the antenna units 12 and the phase shifters 22 correspond one to one. That is, each group of phase shifters also includes two adjacent phase shifters 22 located in the a^{th} row and one phase shifter 22 located in the a+1^{th} row or the a−1^{th} row. In each group of phase shifters, the phase of the input signal of each phase shifter 22 to the corresponding antenna unit 12 is a multiple of the minimum unit input phase of the phase shifter 22, where N is a positive integer greater than or equal to 3, and the multiple is 0 or any integer.

In some embodiments, in each group of phase shifters, the phases of the input signals from two adjacent phase shifters along the x direction to the corresponding antenna units 12 are two different multiples of the minimum unit input phase of the phase shifter 22. For example, along the x direction, the phase difference of the input signal of each two adjacent phase shifters separated by the spacing distance d to the corresponding antenna unit 12 is 1 times Φₘ, that is, 0, Φₘ, 2Φₘ, 3Φₘ, 4Φₘ, . . . , (n−1)Φₘ. For instance, in a group of phase shifters, when the phases of the input signals from two adjacent phase shifters separated by the spacing distance d along the x direction to the corresponding antenna units 12 are 0 and Φₘ, the phase of the input signal from the phase shifter located in another adjacent row to the corresponding antenna unit 12 can be 0 or Φₘ. In another group of phase shifters, when the phases of the input signals from two adjacent phase shifters separated by the spacing distance d along the x direction to the corresponding antenna units 12 are Φₘ and 2Φₘ, the phase of the input signal from the phase shifter located in another adjacent row to the corresponding antenna unit 12 can be Φₘ or 2Φₘ. In another group of phase shifters, when the phases of the input signals from two adjacent phase shifters separated by the spacing distance d along the x direction to the corresponding antenna units 12 are 2Φₘ and 3Φₘ, the phase of the input signal from the phase shifter located in another adjacent row to the corresponding antenna unit 12 can be 2Φₘ or 3Φₘ. In another group of phase shifters, when the phases of the input signals from two adjacent phase shifters separated by the spacing distance d along the x direction to the corresponding antenna units 12 are 3Φₘ and 4Φₘ, the phase of the input signal from the phase shifter located in another adjacent row to the corresponding antenna unit 12 can be 3Φₘ or 4Φₘ. In another group of phase shifters, when the phases of the input signals from two adjacent phase shifters separated by the spacing distance d along the x direction to the corresponding antenna units 12 are 4Φₘ and 5Φₘ, the phase of the input signal from the phase shifter located in another adjacent row to the corresponding antenna unit 12 can be 4Φₘ or 5Φₘ.

In some embodiments, in the N*M phase shifters 22 of each group of phase shifters, the component angles θx and θy of the specific pointing angles of the radio beam (or beamforming signal) emitted by the antenna array 10 in the x direction and the y direction can be obtained by formula (12):

$${θ}_{x} = - {sin}^{- 1} ( \frac{λ}{d 1} \times \frac{∅}{360} ) , {θ}_{y} = - {sin}^{- 1} ( \frac{2 λ}{\sqrt{3} d 2} \times \frac{∅}{360} ) \qquad formula ( 12 )$$

Wherein, λ is the wavelength of the RF input signal, d is the spacing distance between two adjacent antenna units 12, Φ is the minimum unit input phase of the phase shifter 22, that is Φ=Φₘ.

In some embodiments, in each group of phase shifters 22 arranged in a planar isosceles triangle, the phase of the input signal from each phase shifter 22 to the corresponding antenna unit 12 can be calculated using different formulas according to the arrangement position of the phase shifter 22. When M of the (N, M)^{th} phase shifter 22 is an odd number, the phase of the input signal from the (N, M)^{th} phase shifter 22 to the corresponding antenna unit 12 can be calculated by formula (13):

$$∅ = Round ( \frac{2 π \times d x \times sin ( {θ}_{x} )}{λ \times {∅}_{m}} ) ( n - 1 ) {∅}_{m} + Round ( \frac{√ 3 \times π \times d \times sin ( {θ}_{y} )}{λ \times {∅}_{m}} ) ( m - 1 ) {∅}_{m} \qquad formula ( 13 )$$

When M of the (N, M)^{th} phase shifter 22 is an even number, the phase of the input signal from the (N, M)^{th} phase shifter 22 to the corresponding antenna unit 12 can be calculated by formula (14):

$$∅ = ( Round ( \frac{2 π \times d x \times sin ( {θ}_{x} )}{λ \times {∅}_{m}} ) + Round ( \frac{2 π \times d x \times sin ( {θ}_{x} )}{2 \times λ \times {∅}_{m}} ) ) ( n - 1 ) {∅}_{m} + Round ( \frac{√ 3 \times π \times d \times sin ( {θ}_{y} )}{λ \times {∅}_{m}} ) ( m - 1 ) {∅}_{m} \qquad formula ( 14 )$$

Wherein, Φ is the phase of the input signal of the phase shifter 22 to the corresponding antenna unit 12, θx, θy=−180°˜180°, λ is the wavelength of the RF input signal, d is the spacing distance between two adjacent antenna units 12, Φₘ is the minimum unit input phase of the phase shifter 22, and Round( ) is rounded to the nearest integer.

For instance, the phase of the input signal of each phase shifter 22 to the corresponding antenna unit 12 is a multiple of the minimum unit input phase Φₘ of the phase shifter 22, Φₘ=5.625°, the center frequency of the RF input signal is 11.7 GHz (Gigahertz), the wavelength λ of the RF input signal is 25.641 mm (millimeters), and the spacing distance d between two adjacent antenna units 12 is 12 mm. If the formula (1) is substituted for calculation, the specific pointing angle θ of the radio beam in the x direction is approximately 3.829°; if the formula (12) is substituted for calculation, the component angle θx of the specific pointing angle θ of the radio beam in the x direction is approximately 1.918°, that is, the minimum adjustable angle of the antenna array 10 in the x direction is approximately 1.918°.

From formula (12) to formula (14), it can be calculated that the specific pointing angle θ=θₘ/2 of the radio beam emitted by the antenna array 10, therefore, the beamforming resolution (or the minimum adjustable beam angle) can be increased by 2 times, so that the minimum adjustable angle of the beam of the antenna array 10 is smaller, and the adjustable beam emission of the antenna array 10 is more precise.

In the antenna module of the embodiments of the present application, N−2 intermediate phase shifters are interspersed between the first phase shifter and the N^{th} phase shifter, and the phase of the input signal of each of the N phase shifters is a multiple of the minimum unit input phase of the phase shifter, that is, the input phases of the N phase shifters are all multiples of the minimum unit input phase of the phase shifter, so that the angle of the beam formed by the antenna array is more precise, and the antenna module has a higher beam adjustable accuracy.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. An antenna module for a low earth orbit satellite system comprising:
an antenna array comprising a plurality of groups of antenna units, each of the plurality of groups of antenna units comprising N antenna units; and
a phase shifter array comprising a plurality of groups of phase shifters, each of the plurality of groups of phase shifters comprising N phase shifters arranged corresponding to the N antenna units, wherein the N phase shifters comprises a first phase shifter, a N^{th} phase shifter, and N−2 intermediate phase shifters arranged between the first phase shifter and the N^{th} phase shifter, a phase of an input signal of each of the N phase shifters to the corresponding antenna unit is a multiple of a minimum unit input phase of the phase shifter, wherein N is a positive integer greater than or equal to 3, and the multiple is 0 or any integer.

2. The antenna module of claim 1, wherein the N antenna units are arranged in two dimensions.

3. The antenna module of claim 1, wherein in each two adjacent rows of the antenna units of the plurality of groups of antenna units, one antenna unit located in one of the two adjacent rows is correspondingly arranged between two adjacent antenna units located in another one of the two adjacent rows.

4. The antenna module of claim 3, wherein each of the plurality of groups of antenna units comprises at least two adjacent antenna units located in an a^{th} row and one antenna unit located in an a+1^{th} row or an a−1^{th} row, and the antenna unit located in the a+1^{th} row or the a−1^{th} row is correspondingly arranged between the two adjacent antenna units located in the a^{th} row, the antenna unit located in the a+1^{th} row or the a−1^{th} row is respectively arranged at an equal spacing distance from the two adjacent antenna units located in the a^{th} row, so that the group of antenna units forms a planar regular triangle or a planar equilateral triangle arrangement.

5. The antenna module of claim 1, wherein in each of the plurality of groups of antenna units, the phases of the input signals from the two adjacent phase shifters of the N−2 intermediate phase shifters to the corresponding antenna units are two different multiples of the minimum unit input phase of the phase shifter.

6. The antenna module of claim 3, wherein each of the plurality of groups of antenna units comprises at least two adjacent antenna units located in an a^{th} row and one antenna unit located in an a+1^{th} row or an a−1^{th} row, and the antenna unit located in the a+1^{th} row or the a−1^{th} row is correspondingly arranged between the two adjacent antenna units located in the a^{th} row, the two adjacent antenna units located in the a^{th} row are arranged at a first spacing distance, and the antenna unit located in the a+1^{th} row or the a−1^{th} row is respectively arranged at a second spacing distance with the two adjacent antenna units located in the a^{th} row, so that the group of antenna units forms a planar isosceles triangle arrangement.

7. The antenna module of claim 1, wherein each of the plurality of groups of antenna units comprises at least N antenna units linearly arranged along an x direction and at least M antenna units linearly arranged along a y direction, thereby forming an N*M planar rectangular arrangement, the at least N antenna units are linearly arranged along the x direction at a first spacing distance, the at least M antenna units are linearly arranged along the y direction at a second spacing distance.

8. The antenna module of claim 1, wherein in the N−2 intermediate phase shifters arranged between the first phase shifter and the N^{th} phase shifter, the phase of the input signal of each of the N−2 intermediate phase shifters to the corresponding antenna unit is equal to the phase of the input signal of the first phase shifter to the corresponding antenna unit or the phase of the input signal of the N^{th} phase shifter to the corresponding antenna unit, or is between the phase of the input signal of the first phase shifter to the corresponding antenna unit and the phase of the input signal of the N^{th} phase shifter to the corresponding antenna unit.

9. The antenna module of claim 8, wherein in the N−2 intermediate phase shifters arranged between the first phase shifter and the N^{th} phase shifter, the phases of the input signals of the N−2 intermediate phase shifters to the corresponding antenna units are increasing or decreasing, and are multiples of the minimum unit input phase of the intermediate phase shifter.

10. The antenna module of claim 1, further comprising a radio frequency distribution network, wherein the antenna array, the phase shifter array, and the radio frequency distribution network are connected in sequence to form a radio beam transceiver path.

11. A wireless communication device for a low earth orbit satellite system comprising:
an antenna array comprising a plurality of groups of antenna units, each of the plurality of groups of antenna units comprising N antenna units; and
a phase shifter array comprising a plurality of groups of phase shifters, each of the plurality of groups of phase shifters comprising N phase shifters arranged corresponding to the N antenna units, wherein the N phase shifters comprises a first phase shifter, a N^{th} phase shifter, and N−2 intermediate phase shifters arranged between the first phase shifter and the N^{th} phase shifter, a phase of an input signal of each of the N phase shifters to the corresponding antenna unit is a multiple of a minimum unit input phase of the phase shifter, wherein N is a positive integer greater than or equal to 3, and the multiple is 0 or any integer.

12. The wireless communication device of claim 11, wherein the N antenna units are arranged in two dimensions.

13. The wireless communication device of claim 11, wherein in each two adjacent rows of the antenna units of the plurality of groups of antenna units, one antenna unit located in one of the two adjacent rows is correspondingly arranged between two adjacent antenna units located in another one of the two adjacent rows.

14. The wireless communication device of claim 13, wherein each of the plurality of groups of antenna units comprises at least two adjacent antenna units located in an a^{th} row and one antenna unit located in an a+1^{th} row or an a−1^{th} row, and the antenna unit located in the a+1^{th} row or the a−1^{th} row is correspondingly arranged between the two adjacent antenna units located in the a^{th} row, the antenna unit located in the a+1^{th} row or the a−1^{th} row is respectively arranged at an equal spacing distance from the two adjacent antenna units located in the a^{th} row, so that the group of antenna units forms a planar regular triangle or a planar equilateral triangle arrangement.

15. The wireless communication device of claim 11, wherein in each of the plurality of groups of antenna units, the phases of the input signals from the two adjacent phase shifters of the N−2 intermediate phase shifter to the corresponding antenna units are two different multiples of the minimum unit input phase of the phase shifter.

16. The wireless communication device of claim 13, wherein each of the plurality of groups of antenna units comprises at least two adjacent antenna units located in an a^{th} row and one antenna unit located in an a+1^{th} row or an a−1^{th} row, and the antenna unit located in the a+1^{th} row or the a−1^{th} row is correspondingly arranged between the two adjacent antenna units located in the a^{th} row, the two adjacent antenna units located in the a^{th} row are arranged at a first spacing distance, and the antenna unit located in the a+1^{th} row or the a−1^{th} row is respectively arranged at a second spacing distance with the two adjacent antenna units located in the a^{th} row, so that the group of antenna units forms a planar isosceles triangle arrangement.

17. The wireless communication device of claim 11, wherein each of the plurality of groups of antenna units comprises at least N antenna units linearly arranged along an x direction and at least M antenna units linearly arranged along a y direction, thereby forming an N*M planar rectangular arrangement, the at least N antenna units are linearly arranged along the x direction at a first spacing distance, the at least M antenna units are linearly arranged along the y direction at a second spacing distance.

18. The wireless communication device of claim 11, wherein in the N−2 intermediate phase shifters arranged between the first phase shifter and the N^{th} phase shifter, the phase of the input signal of each of the N−2 intermediate phase shifters to the corresponding antenna unit is equal to the phase of the input signal of the first phase shifter to the corresponding antenna unit or the phase of the input signal of the N^{th} phase shifter to the corresponding antenna unit, or is between the phase of the input signal of the first phase shifter to the corresponding antenna unit and the phase of the input signal of the N^{th} phase shifter to the corresponding antenna unit.

19. The wireless communication device of claim 18, wherein in the N−2 intermediate phase shifters arranged between the first phase shifter and the N^{th} phase shifter, the phases of the input signals of the N−2 intermediate phase shifters to the corresponding antenna units are increasing or decreasing, and are multiples of the minimum unit input phase of the intermediate phase shifter.

20. The wireless communication device of claim 11, further comprising a radio frequency distribution network, wherein the antenna array, the phase shifter array, and the radio frequency distribution network are connected in sequence to form a radio beam transceiver path.
